(19) United States
(12) Patent Application Publication
(10) Pub. No.: US 2004/0256184 A1
(43) Pub. Date: Dec. 23, 2004

(54) Arrangement and a method for activating and deactivating the braking system of a trailer

(76) Inventors: Mattias Liljeberg, Skarholmen (SE); Michael Liljeberg, Skarholmen (SE)

Correspondence Address: OSTROLENK FABER GERB & SOFFEN, 1180 AVENUE OF THE AMERICAS, NEW YORK, NY, 100368403

(21) Appl. No.: 10/491,555

(22) PCT Filed: Oct. 4, 2002
(86) PCT No.: PCT/SE02/01820

(30) Foreign Application Priority Data
Oct. 4, 2001 (SE) 0103270-5

(51) Int. Cl. B60T 7/20

(52) U.S. Cl. 188/112 R

(57) ABSTRACT

This invention relates to an arrangement for the brakes of a trailer (2), the purpose of the arrangement being with the aid of the power transmission from a hauling vehicle to the trailer to apply or release the brakes in the braking system of the trailer. The invention does also concern a method for activation and deactivation of the brakes of a trailer with use of the power transmission from the hauling vehicle to the trailer (2). The brakes can be activated in the situation when the force transmission to the trailer (2) is reduced or absent when the trailer (2) is standing still. The brakes can be deactivated when the clutch device (5) connected to the pulling hook (17) of the towing vehicle is subjected to a pulling hook (17) of the towing vehicle is subjected to a pulling force, so that the braking system (2) of the trailer is activated as soon as there is no pulling force from the vehicle. According to the method the braking system of the trailer (2) is activated as soon as there is no pulling force from the vehicle and the braking system of the trailer (2) is deactivated as soon as the trailer (2) detects a pulling power from the vehicle.

The present invention relates to an arrangement and a method for activating and deactivating the braking system of a trailer by utilization of power transmission to the trailer from a hauling vehicle. The brakes which today are used in trailers operate in the way that the brakes of the trailer are activated by a pushing force from the trailer which actuates upon the hauling vehicle. In the situation when such a pushing force is not exerted by the trailer its brakes are in a not activated state, permitting the trailer to roll freely. Consequently, when the motor vehicle is parked, the trailer must be kept in a braked condition by a separate hand brake.

The object of the present invention is to make it possible to activate the brakes of a trailer in absence of a pushing force from the trailer effecting the hauling vehicle. This results in a more efficient braking action and, in addition thereto, makes it possible for light vehicle in a more efficient way to brake heavier trailers. The features characterizing the invention are set out in the subsequent patent claims.

Thanks to the invention there has now been provided an arrangement and a method permitting a mode of functional operation for the brakes of a trailer, which in an excellent manner satisfy the intentions with the additional advantage that the device proper is structurally simple and cheap to manufacture. The technique of the arrangement according to the invention is very simple and it is possible to combine it or to use as a supplement to the state of the art of today braking systems used in trailers. The basic idea of the invention is to make it possible to activate the braking system of a trailer as soon as that system does not detect any pulling force from the hauling vehicle. When the brakes of the trailer are combined with a traditional braking system they will upon a powerful braking get activated earlier than when the state of the art technique is used. Further advantage is that both slower breakings, for example with the aid of the motor, and weak breakings can be made without this causing the trailer to subject the hauling vehicle to a pushing force from the trailer. Additional advantages of a trailer according to the invention as compared with traditional trailers are as follows. The road safety will be higher thanks to the reduced risks of the trailer starting to “wobble”. Another factor increasing the traffic safety is that safety line between the trailer and the hauling vehicle can be integrated in the system. This smother braking of the trailer results in softer jerks and jolt meaning increased comfort for the passengers and reduced wear of the clutch devices connecting the hauling vehicle with the trailer. There will also be less wear of the brakes of the hauling vehicle and more even power transmission during starting operation. This means that the hauling vehicle, instead of being subjected to a butt jerk when starting to roll the coupling will offer a more even power distribution when the spring means used according to the invention is actuated to release the brakes. Finally the invention offers a simple design, which can be used to supplement the traditional equipment when desired.

The invention will now be described more in detail, reference being made to the enclosed drawing, in which

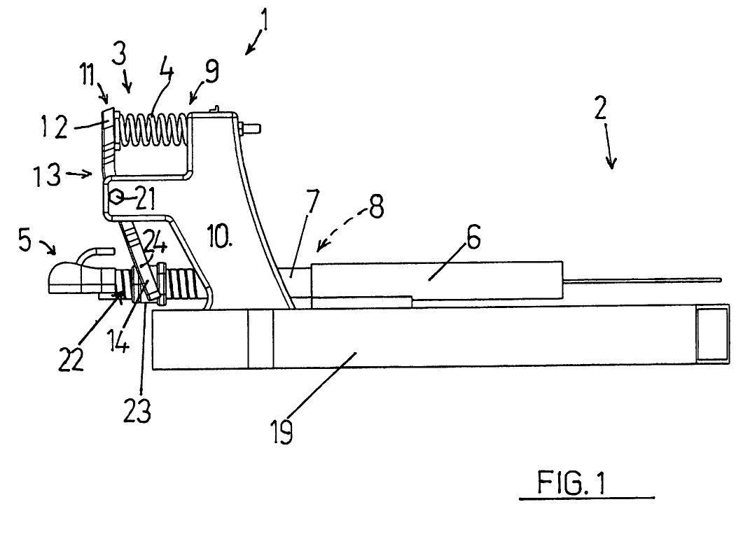

FIG. 1 is a lateral view showing a first embodiment of the invention,

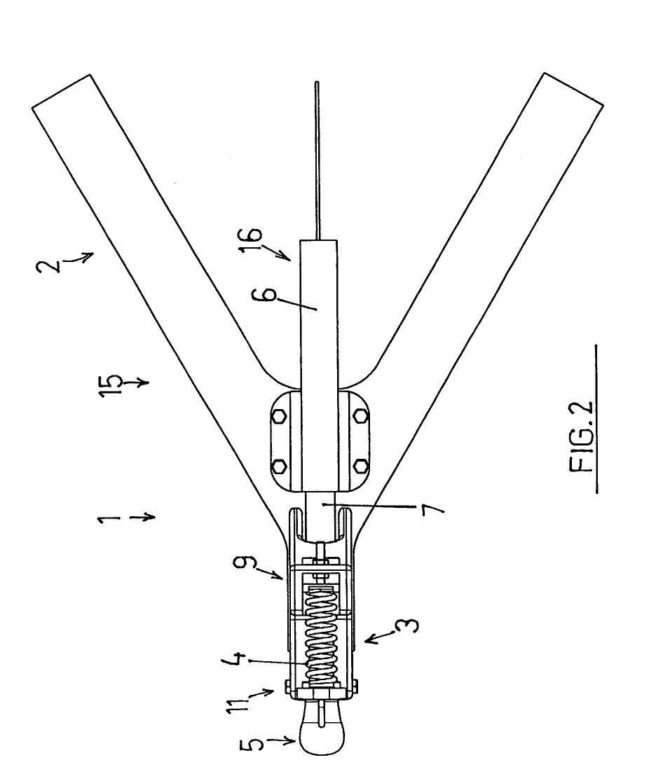

FIG. 2 is a top view of the embodiment shown in FIG. 1 and

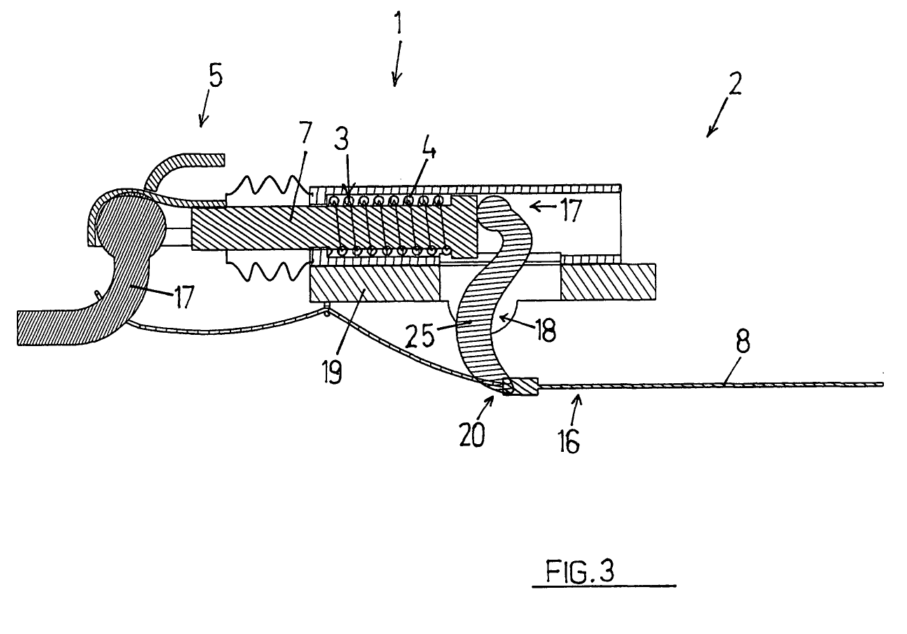

FIG. 3 does in a lateral view illustrate an alternative embodiment showing a braking device according to the invention.

FIGS. 1 and 2 show an embodiment, which illustrate the function of a braking device 1 according to the invention when installed in a typical trailer 2. A spring member 3 in the shape of a helical spring 4 is used to activate the brakes of the brakes in the braking system. When the clutch device 5, which is connected to the traction hook 17 is subjected to a traction force the brakes are deactivated due to reduction of the pressure in a master cylinder 6 to which the clutch device is displaceable connected via an extended portion or a traction rod 7. Alternatively a wire 8 can be connected to the brakes in order to release them. When the helical spring 4 is compressed the result thereof will be that the brakes are released as soon as the traction force of the hauling vehicle is conveyed to the trailer 2. The function involving compression of the helical spring 4 upon application of the pulling force results in a successive power transmission between the trailer and the pulling vehicle. In this way one avoids heavy jerks, such as sudden starts, and the brakes of the trailer are released successively. When the pulling force of the hauling vehicle is reduced, for example during motor braking, the helical spring 4 is extended towards its normal position, or rest position, and the brakes of the trailer 2 are activated. Stated in other words it could be said that the vehicle does always “pull” the trailer. According this embodiment the spring 4 is mounted with its one end 9 connected to the chassis 19 of the trailer via a support post 10. The other end 11 is attached to the free end of a lever 13, which via a pivot pin 21 is supported by the post 10. The other end 14 of the lever 13 is suitably and pivotably connected to the pulling rod 7 via an external thread 22, a nut 23 and a pivot pin 24. It is naturally possible to use as the spring member 3 any other equivalent means which can provide the same function as the helical spring 4, for example a leaf spring device, a pneumatically or hydraulically operating means etc.

In the embodiment shown in FIG. 3 the brake operates in the same way as according to the first embodiment but the spring member 3 is here in the shape of a helical spring 4 which surrounds the polling rod 7 and is mounted in such a way that, also in this case, the helical spring 4 will be compressed when a pulling force is applied causing simultaneous deactivation of the brakes of the trailer 2. According to both embodiments the pulling rod 7 is displaceable mounted in the front portion 15 of the trailer. The displacement movement of the rod takes place along a predetermined distance extending from a inserted rest position, in which the brakes are activated as caused by the spring member 3, and an extended active position in which the brakes are released, the spring action having been suspended by the pulling force from the vehicle. A governor 16 controlled by the pulling rod 7 does alternately activate and deactivate the braking system of the trailer 2.

In this second embodiment the one end 17 of a lever 18 is connected to the pulling rod 7 and the lever 18 is pivotally attached to the chassis 19 of the trailer 2 via a pivot axle 25. The opposite end 20 the lever 18 is pivotally connected to the governor 16 controlling the braking system. With the aid of the spring 4 the lever 18 acts to maintain the rod 7 in its rest position or inserted position, as long as the rod 7 and the related clutch device is not subjected to a pulling force upon deactivation of the brakes.

1. A braking device for a trailer (2) designed, with the aid of the power transmission between a hauling vehicle and its trailer (2), to activate or release the brakes in the braking system of the trailer (2), characterized in that the brakes are adapted to be activated when the power transmission to the trailer (2) is reduced or absent due to the trailer (2) being stationary, and that the brakes are adapted to be deactivated when the clutch device (5) connected to the hauling vehicle is subjected to a pulling force, said clutch device (5) being, via an extension or a pulling rod (7), displaceably mounted in the front portion (15) of the trailer (2) a predetermined distance from an inserted idle position, in which the brakes are activated influenced by a spring member (3) to an extended active position, in which the brakes are released and the spring effect suspended, a governor (16) controlled by the pulling rod (7) being adapted alternatively to activate or deactivate the braking system of the trailer (2), activation of the braking system of the trailer (2) taking place immediately upon absence of a pulling force from the hauling vehicle.

2. A device according to claim 1, characterized in that said spring member (3) consists of a helical spring (4) the one free end (9) of which is resting against the chassis (19) of the trailer (2) and its other free end (11) against the one end (12) of a lever (13), which in its turn is pivotably attached to the chassis (19) of the trailer (2), the other end (14) of the lever being adjustably and pivotably connected to the pulling rod (7), said lever (13), assisted by the helical spring (4), acts to maintain the pulling rod (7) in its idle position or the inserted position as long as the clutch device (5) along with its related pulling rod (7) is not subjected to a pulling force upon deactivation of the brakes.

3. A device according to claim 2, characterized in that the brake system governor (16) comprises a master cylinder (6), in which the pulling rod (7) is mounted displaceably to generate a positive pressure, causing activation of the brakes or a negative pressure causing deactivation of the brakes, respectively.

4. A device according to claim 1 or 2, characterized in that the braking system governor is constituted by a mechanical arrangement in the shape of a wire (8) connected to the pulling rod (7) and the brake system to cause activation or release of the brakes, the spring force being reduced simultaneously with extension of the helical spring (4) and the spring force being increased simultaneously with interruption of the spring effect.

5. A method for activation and deactivation of the brakes of a trailer with utilization of the transmission of power from a hauling vehicle to the trailer (2), characterized in that the braking system of the trailer (2) is activated immediately upon interruption of a pulling force from the hauling vehicle and is deactivated as soon as the trailer (2) detects a pulling force from the hauling vehicle, an application of a pulling force from a hauling vehicle triggering displacement of a pulling rod (7) constituting an extension of the clutch device, which is connected to the hauling vehicle, forwards from a first, spring-biased idle position to a second spring-biased position, the spring action being discontinued with simultaneous deactivation of the braking system of the trailer (2), whereas, in absence of a pulling force from the hauling vehicle and when the latter is slowed down, the pulling rod (7) is displaced backward towards its first spring-biased idle position to cause activation of the braking system.
